(19) United States
(12) Patent Application Publication
(10) Pub. No.: US 2025/0020553 A1
(43) Pub. Date: Jan. 16, 2025

(54) Moisture Chamber with Workstation for Immunofluorescence Staining, Processing and Storing Coverslips with Minimal Forceps Handling

(71) Applicant: Anthony Stevens, Fairborn, OH (US)

(72) Inventor: Anthony Stevens, Fairborn, OH (US)

(21) Appl. No.: 18/353,057

(22) Filed: Jul. 14, 2023

(51) Int. Cl. G01N 1/30; G01N 1/31

(52) U.S. Cl. CPC G01N 1/30; G01N 1/312; G01N 2001/315

(57) ABSTRACT

This IF Moisture Chamber and Workstation related processes result in an optimal environment that reduces risk of poor quality IF staining & processing outcomes. This workstation results in less antibody consumption and end to end processing costs reduction for standard IF staining protocols. The universal dish and imbedded devices are multipurpose and can be reused to simultaneously process up to six small circular 12 millimeter diameter coverslips or two standard larger sized circular or square coverslips This workstation eliminates the need to use a forceps to precisely grasp, hold, move and tilt each individual coverslip multiple times for fluid removal during a series of repetitive staining and dumping activities typically required for full processing of each coverslip. Consequently this device facilitates exceeding storage and processing standards correlated with high quality coverslips' specimens staining for subsequent mounted slides placed under microscopic examination and image capture of specimen cell structures and compositions.

### CROSS-REFERENCE TO RELATED APPLICATIONS

There have not been search results found regarding applications or patents issued with similar product functionality, features or moisture chamber technical specifications. The following patent application was found related to an immunofluorescence (IF) staining and storage chamber. U.S. patent Ser. No. 17/501,386 Oct. 14, 2021.

### BACKGROUND OF THE INVENTION

Immunofluorescence (IF) is widely used for the visualization and quantification of target proteins in tissue or cells adhered to a coverslip. Minimizing the inherent risk of error in coverslip staining and processing is crucial to produce reliable, reproducible IF results. Some common IF obstacles include coverslip handling errors, inadequate specimen moisture, and light-induced signal corruption. Repetitive staining and dumping require handling each coverslip multiple times with forceps to complete IF processing. Every time coverslips are moved with forceps, there is a risk of mishandling specimens. Excessive coverslip handling during the required series of staining and washing steps can easily damage cells or tissue, and dropping a coverslip typically results in complete specimen loss.

Coverslip handling obstacles are further complicated by IF storage and incubation environmental requirements. Standard transparent polystyrene petri dishes are commonly modified for storage and incubation. Platforms are commonly designed and fabricated from a variety of lab supplies designed for other primary uses to allow airflow under coverslips. Adhesives are typically used to affix these temporary makeshift platforms to the bottom of the dish surface area. Coverslips must remain in humidified conditions during incubation and processing to prevent the specimen or antibody from drying prematurely. Water saturated cloths are often placed in petri dishes to humidify refrigerator and benchtop storage environments. Additionally, transparent petri dishes must be covered with foil or similar material to ensure light exposure does not diminish specimen visualization when working with fluorescent probes. These numerous modifications are time consuming and do not address the risk of repeatedly handling standard size circular or square coverslips. Common IF obstacles prevent further specimen processing and analysis and lead to experimental delays that cost time and money. It is crucial to employ strategies to mitigate the risks involved in coverslip IF processing.

### BRIEF SUMMARY OF THE INVENTION

The proposed product and processes facilitate an optimal immunofluorescence (IF) environment for coverslips to reduce the risk of unfavorable outcomes. By optimizing IF processing of coverslips, this product simplifies generation of high-quality staining of target proteins for microscopic examination and image capture. Product features include a dish storage device which can be made of various glass or plastics ranging from transparent to opaque as dictated by experimental design requirements. Several product features mitigate potential IF processing errors and inefficiencies. The prospective opacity of the dish exterior protects fluorescent samples from degrading due to light exposure.

The dish interior has several other design structures to support efficient, high quality processing results. There are two rectangular built-in reservoirs along the inside bottom of the dish surface to store water to ensure adequate humidity within the chamber during storage and incubation periods. There are two large independent removable universal coverslip processing platforms that fit inside the dish. These circular platforms can be placed securely within a built in edge surrounding its perimeter that prevents unintended movement during coverslip processing cycles. The two large processing platforms have three small platforms fixed atop the larger removable platform bases. Six small circular twelve-millimeter diameter coverslips can be processed in same or segregated batches of three smaller platforms that sit atop each of the 2 large removable universal coverslip processing platforms. Secured storage of each small twelve-millimeter diameter coverslip is achieved by a small platform elevated edge along the outside perimeter of each sunken platform surface. All six small platforms are numbered to allow logical organization and reference for individually placed coverslips. Removing and tilting large platforms by hand allows wicking fluid from the edge of coverslip surfaces with less risk of unintended coverslip movement and specimen cell damage compared to using forceps. This feature virtually eliminates having to precisely grasp, hold, move, and tilt each individual coverslip multiple times with forceps to remove fluid and complete a series of repetitive staining and dumping activities typically required for repetitive processing cycles for each coverslip specimen.

Additionally this same IF staining, storage, and processing device can be similarly used for processing and storage of larger commonly manufactured and produced circular or square shaped coverslips that house specimen cells for IF storage, staining and processing. This one universal device is multipurpose and can be reused to process up to two larger sized circular or square coverslips greater than twelve-millimeters. There are four corner posts and holders to support each larger circular or square coverslip that rises vertically from the platforms. the posts with cutouts secure coverslips on a horizontal plane above where smaller platform twelve-millimeter circular coverslips can be securely placed. Each chamber can support processing two larger secured circular or square coverslips or up to six smaller twelve-millimeter diameter secured circular coverslips during a single processing cycle.

The same functions and features previously described to facilitate and secure small 12 millimeter circular coverslips during incubation storage and repetitive processing cycles are leveraged and utilized to support efficient, high quality storage and processing results of specimen cells placed on commonly produced larger standard sized circular or square coverslips.

### BRIEF DESCRIPTION OF THE SEVERAL VIEWS OF THE DRAWING

FIG. 1 Is a top down view of the IF moisture chamber lid, which would be placed on top of IF moisture chamber illustrated in FIG. 2

FIG. 2 Is a top down view of the IF moisture chamber

FIG. 3 is a top down angled view illustrating depth of the IF moisture chamber lid, previously shown in FIG. 1.

FIG. 4 is a top down angled view illustrating depth of the IF moisture chamber, previously shown in FIG. 2

FIG. 5 is a front, top down angled view displaying universal coverslip processing removable large platform 1

FIG. 6 is a front, top view displaying universal coverslip processing removable large platform 2

FIG. 7 Is a top down view of the universal coverslip processing removable large platform 1, previously illustrated in FIG. 5

FIG. 8 is a top down view of the universal coverslip processing removable large platform 2, previously illustrated in FIG. 6

FIG. 9 is a rear, top down angled view displaying universal coverslip processing removable large platform 2, previously illustrated in FIG. 6

FIG. 10 is a rear, top down angled view displaying universal coverslip processing removable large platform 1, previously illustrated in FIG. 5

FIG. 11 is a top down front angled view of the universal coverslip processing removable large platform 1 with a 12 millimeter coverslip securely set within the platform with elevated edges marked as roman numeral “II”.

FIG. 12 is a top down front angled view of the universal coverslip processing removable large platform 1 with a 22 mm square coverslip securely set within the processing platform

FIG. 13 is a top down angled view of the universal coverslip processing removable large platform 1 with a 16 mm circular coverslip securely set within the processing platform.

FIG. 14 is a top down angled view of the universal coverslip processing removable large platform 1 with an 18 mm circular coverslip securely set within the processing platform

FIG. 15 is a top down angled view of the total prototype displaying both universal coverslip processing removable large platforms 1 & 2 inserted within the moisture chamber; the universal coverslip processing platform 2 within the moisture chamber possess three 12 mm coverslips on top of small platforms four thru six.

FIG. 16 is a top down angular view of the moisture chamber lid, previously illustrated in FIG. 1

### DETAILED DESCRIPTION OF THE INVENTION

There is an IF humidity storage device for large sized slides currently available in the marketplace. However this device is designed for use with standard sized large slides only. It only addresses the humidity and storage issues associated with slide mounted specimens that sit atop the large slide surfaces.

This new moisture chamber and associated benchtop workstation devices can be made of durable plastic or glass properties typically found in variations of commonly available petri dish materials compositions. The new device provides functionality and processing capability for specimen cells on coverslips. Downstream higher quality visualizations under microscopes are possible with small coverslips and opposed to standard large slide mounted specimens between two large slides. The small and larger sized coverslips processing dish and all supporting workstation devices will be made of similar materials with varied levels of light penetrating properties.

Additionally, the new device will result in less antibodies consumed and overall staining process costs reduction to develop and produce high quality images captured for microscope visualizations. Common and historical IF industry practice entails flooding the entire bottom of a standard petri dish with enough antibodies to completely cover the surface of all coverslips and specimen cells that sit atop the coverslip surfaces. This workstation allows pinpoint application accuracy for any and all subsequent series of required antibodies applications needed to fully complete a required IF staining design protocol. For some studies, antibody consumption and cost could be reduced up to 90% from current standard practices related to IF processing on coverslips.

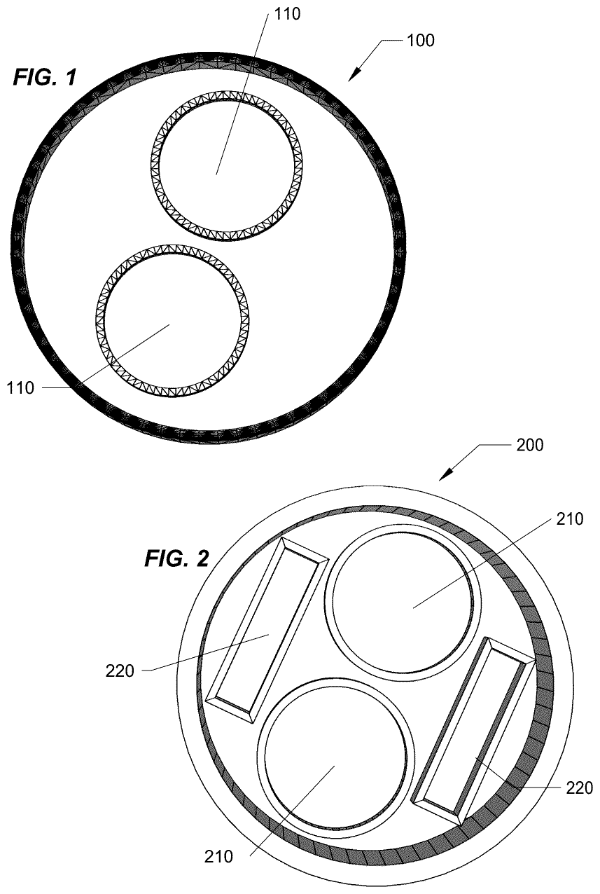

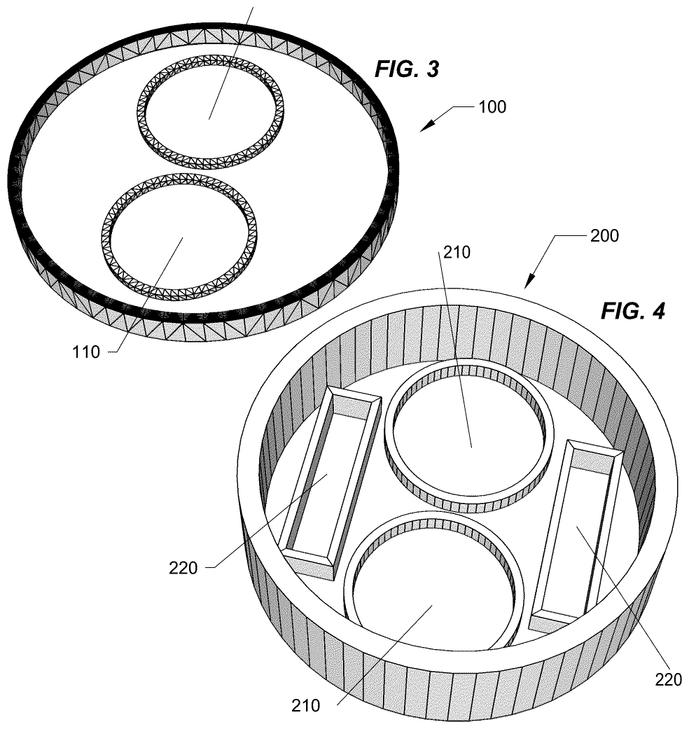

FIGS. 1-4 Illustrate the IF moisture device and lid, the main body of the device. When moisture chamber lid 100, is placed on top of IF moisture chamber 200, the chamber allows humidity and storage of coverslips after processing. Within the IF moisture chamber lid 100, is a circular insert 110. 110 is built-in on the lid to allow coverslip platforms 300 & 400 to be removed from the IF moisture chamber 200 and placed in a secure area during processing. There can be one or two circular inserts 110 present on the chamber lid 100, two circular inserts are present in FIGS. 1 & 3. The coverlid with the circular inserts have a secondary use other than solely being a humidity chamber lid and secure area. It can be used as a processing area that can securely hold the universal coverslip platforms 300 & 400 helping prevent accidental coverslip cross contamination by keeping coverslips securely separated.

FIGS. 2 & 4 displays the IF moisture chamber 200. Within the humidity chamber are four different structures, 210 are the two circular structures found within the IF moisture chambers, 200. The two circular inserts 210, are the main housing and storage area for the large universal coverslip processing platforms 300 & 400. Also displayed in the IF moisture chamber 200, are two square structures 220. The square structures are water reservoirs that provide a humid environment when the device is being used for storage.

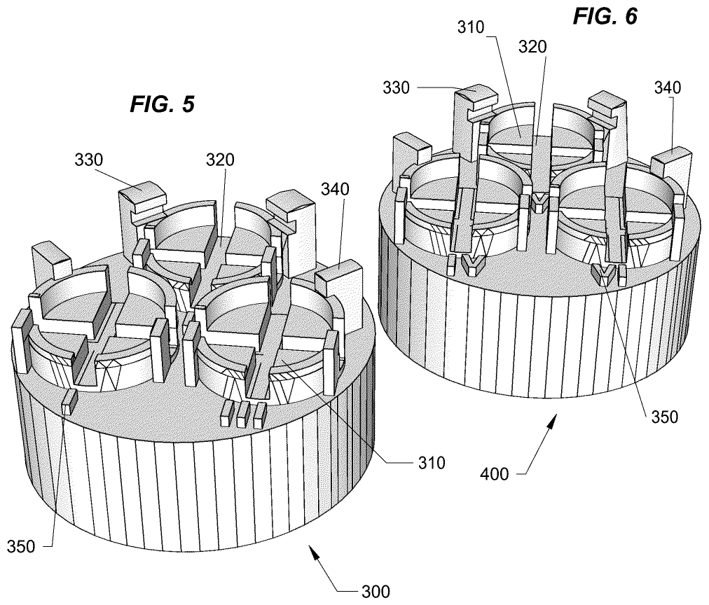

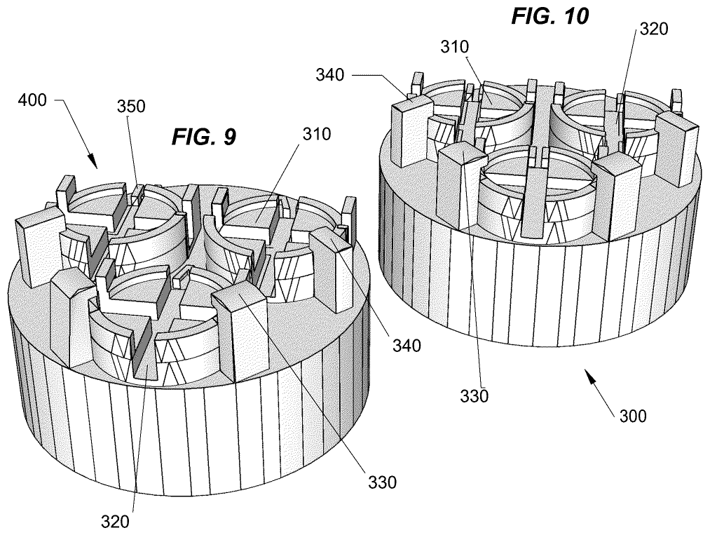

FIGS. 5-10 illustrate the two universal coverslip platforms 300 & 400 at various perspectives. The two universal coverslip platforms 300 & 400 are circular removable large platforms with unique structures on the top of each platform for coverslip immunostaining, processing and storage. Coverslip platforms 300 & 400 are identical other than one feature, the numbering system 350. The roman numeral numbering system 350 is used to help track stained coverslips that are housed within the small circular platforms with elevated edges 310. Coverslip platform 300 contains roman numerals one through three while coverslip platform 400 contains roman numerals four through six. The numbering system does not necessarily need to be roman numerals; the system can be updated based on region or customer preferences where the device is being used.

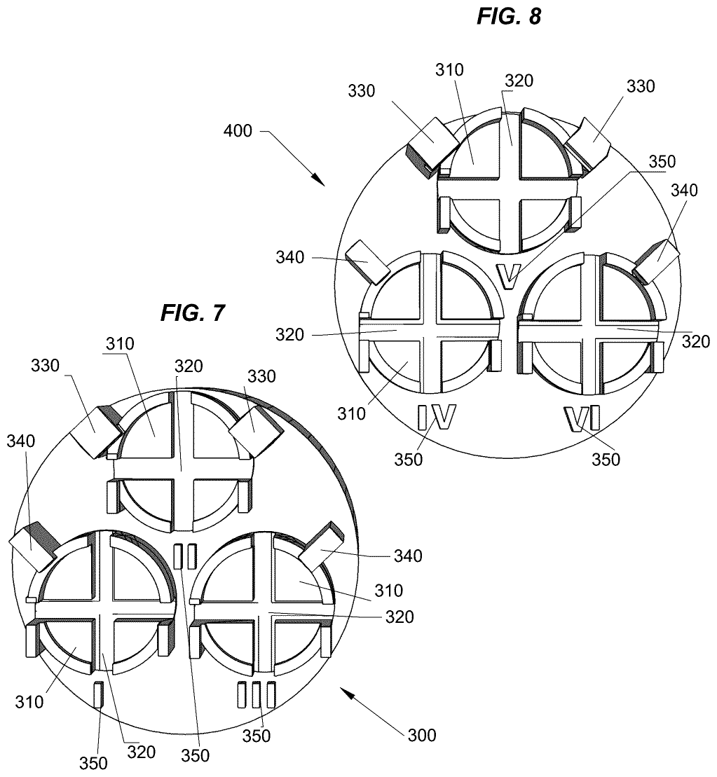

There are a handful of unique structures present on the universal coverslip platforms that secure all sizes of coverslips. FIGS. 7 & 8 illustrate all structures labeled individually. There are three recessed platforms 310, on each coverslip platform 300 & 400. The 6 small built in circular platforms 310, are designed to securely hold 12 millimeter circular coverslips during immunostaining, processing and storage. Underneath the recessed 12 mm coverslip platform is a cross cut groove 320. The cross cut groove 320, is used to allow an air layer underneath the secured 12 millimeter coverslips and allow forceps to easily access to grasp coverslip edges for handling, insertion and removal from the platform. For circular coverslips larger than 12 mm and for square coverslips, 330 & 340 are used to securely hold them in place. Observed in FIGS. 5 & 6, structures 330 are vertical posts with cutouts for securing 22 millimeter square coverslips, 16 millimeter and 18 millimeter circular coverslips in place during processing and storage. Structure 330 is used along with 340 to securely hold 22 mm square coverslips during processing. Structure 340 surely holds coverslips in place, however it does not contain any cutouts.

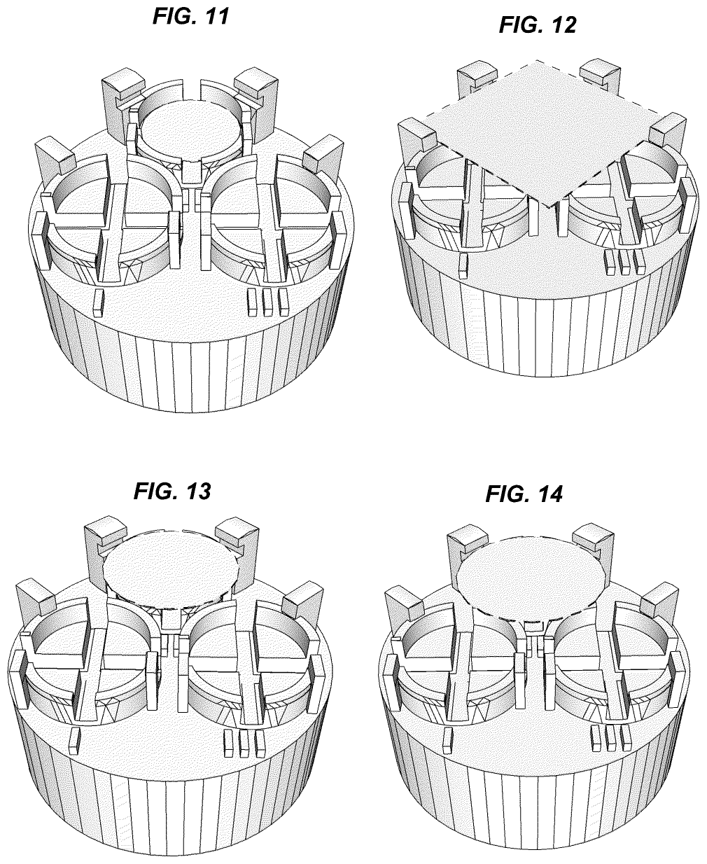

FIGS. 11-14 Illustrate how the platforms are designed to be universal in securing all commonly produced sizes of coverslips for immunostaining, processing and storing. FIG. 11 illustrates a top down front angled view of the universal coverslip platform showing a 12 millimeter coverslip inserted within the small holder 320, roman numeral II. FIG. 12 illustrates a top down front angled view of the universal coverslip platform securely holding a 22 millimeter square coverslip within structure 330 & 340. FIG. 13 Illustrates a top down front angled view of the universal coverslip platform securely holding a 16 millimeter circular coverslip. FIG. 14 illustrates a top down front angled view of the universal coverslip platform securely holding an 18 millimeter circular coverslip.

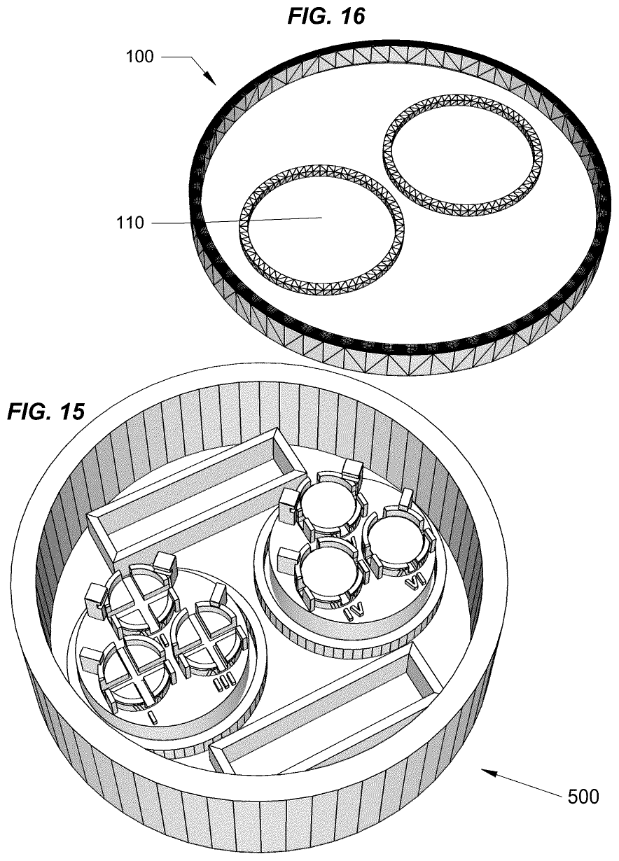

FIGS. 15 & 16 display the entirety of the IF moisture chamber and lid as if it were to be used for processing. Structure 500 displays the IF moisture chamber with both of the universal processing platforms inserted within the moisture chamber to give a comprehensive view of how the devices work together to form a high quality immunostaining processing workstation and storage device.

1. A coverslips moisture chamber and immunostaining processing workstation comprising a chamber base having a removable lid; two removable large platforms; two built-in circular large platform holders, six built-in small circular coverslips platforms with elevated edges having cross cut channels; two built-in water reservoirs; eight posts having coverslip holders.

2. A removable lid as in claim 1 where said lid further comprising a built-in circular large platform edge holder.

3. Two removable large platforms as in claim 1 wherein said large platforms further comprising the six small built-in coverslip platforms with cross cut channels.

4. Six built-in small circular coverslips platforms as in claim 1 where-in said small circular coverslips platforms further comprising elevated circular coverslip perimeter edge holders.

5. Eight posts as in claim 1 wherein said eight posts each further comprising one coverslip edge holder each.

6. Chamber base as in claim 1 wherein said chamber base comprises two built-in large circular platform edge holders.

7. Chamber base as in claim 1 wherein said chamber base further comprises the two built-in water reservoirs.

8. A method of coverslips fixed specimen pre-incubation immunostaining on 12 mm small circular coverslips using the coverslips moisture chamber and immunostaining processing workstation as in claim 1, comprising: coverslips forceps handling; secured insertion and placement of coverslips onto the small circular platforms; hand removal and placement of the large platforms; sequential hand placement of the removable large platforms onto the removable lid circular large platform edge holder; pipette immunostaining of coverslips; filling the water reservoirs on the chamber base; hand placement of removable large platforms into the large circular platform holders on the chamber base; covering the chamber with removable lid, placing the coverslips moisture chamber into the required storage facility for incubation.

9. A method of coverslips fixed specimen pre-incubation immunostaining on larger circular or square coverslips greater than 12 mm using the coverslips moisture chamber and immunostaining processing workstation as in claim 1, comprising: co handling; insertion of secured coverslips placement into the coverslips posts holders; hand removal and placement of the removable large platforms; sequential hand placement of the removable large platforms onto the removable lid circular large platform edge holder, pipette immunostaining of coverslips, filling the water reservoirs on the chamber base, hand placement of removable large platforms into the large circular platform holders on the chamber base, cover the chamber with removable lid, place the coverslips moisture chamber into the required storage facility for incubation.

10. A method of coverslips fixed specimens repetitive immunostaining, washing and dumping cycles of 12 mm small circular coverslips using the coverslips moisture chamber and immunostaining processing workstation as in claim 1, comprising: coverslips forceps handling, secured insertion and placement of coverslips onto the small circular platforms; hand removal and placement of the removable large platforms; sequential hand placement of the removable large platforms onto the removable lid circular large platform edge holder; repetitive pipette immunostaining; repetitive washing and repetitive dumping coverslips as required by varied immunostaining protocols.

11. A method of coverslips fixed specimens repetitive immunostaining, washing and dumping cycles of larger circular or square coverslips greater than 12 mm using the coverslips moisture chamber and immunostaining processing workstation as in claim 1, comprising: forceps secure insertion of coverslips placement into the coverslips posts holders; hand removal and placement of the removable large platforms; sequential hand placement of the removable large platforms onto the removable lid circular large platform edge holder; pipette immunostaining of coverslips; filling the water reservoirs on the chamber base; placement of removable large platforms into the large circular platform holders on the chamber base; cover the chamber with removable lid, place the coverslips moisture chamber into the required storage area for incubation.

12. A method of repetitive washing as in claim 10, further comprising hand removal and hand tilting the removable large platforms; wicking wash fluid away from the secured small 12 mm circular coverslips edges.

13. A method of repetitive washing as in claim 11, further comprising hand removal and hand tilting the removable large platforms; wicking wash fluid away from the secured larger coverslips edges.
